(19) United States
(12) Patent Application Publication
(10) Pub. No.: US 2024/0421527 A1
(43) Pub. Date: Dec. 19, 2024

(54) CONNECTOR

(71) Applicant: Molex, LLC, Lisle, IL (US)

(72) Inventors: Yong Qi Zhao, Chengdu (CN); Jian Chen, Chengdu (CN)

(21) Appl. No.: 18/747,510

(22) Filed: Jun. 19, 2024

(30) Foreign Application Priority Data
Jun. 19, 2023 (CN) 202310730889.8

(51) Int. Cl. H01R 13/506; H01R 13/405; H01R 13/6581

(52) U.S. Cl. CPC H01R 13/506; H01R 13/405; H01R 13/6581

(57) ABSTRACT

A connector includes an outer housing and a wafer. The outer housing is formed with a cavity and a port communicated with the cavity, the outer housing includes a housing retain portion which is positioned in the cavity. The wafer is provided to the cavity and includes a wafer retaining portion retained to the housing retain portion, at least one of the housing retain portion and the wafer retaining portion extends along an inserting direction. Therefore, it can prevent the wafer, which corresponds to the port of the outer housing, from loosening relative to the outer housing in a vertical direction, the wafer is capable of being firmly positioned in the cavity of the outer housing as to promote the electrical connecting performance.

### TECHNICAL FIELD

The present disclosure relates to a connector, and particularly relates to a connector which is adapted to high-speed signal transmission.

### BACKGROUND

China Taiwanese patent document TW202211564A discloses a connector which includes a housing, and a plurality of wafers which are in the housing and have tip ends or top ends thereof to be aligned with a card slot of a port. However, after the plurality of wafers are assembled in the housing, the plurality of wafers are prone to loosen relative to the housing in a vertical direction, thus electrical connecting performance of the connector is affected.

### SUMMARY

Therefore, one of objects of the present disclosure is to provide a connector which can overcome at least one deficiency of prior art.

Accordingly, a connector of the present disclosure comprises an outer housing and a wafer. The outer housing is formed with a cavity and a port communicated with the cavity, the outer housing comprises a housing retain portion which is positioned in the cavity. The wafer is provided to the cavity and comprises a wafer retaining portion retained to the housing retain portion, at least one of the housing retain portion and the wafer retaining portion extends along an inserting direction.

In some embodiments, the housing retain portion is a recessed groove which extends along the inserting direction and is communicated with the cavity, the wafer retaining portion is a protruding block which snaps to the recessed groove.

In some embodiments, the outer housing further comprises a spacing plate which is positioned between the housing retain portion and the cavity, the wafer further comprises a plurality of terminals and a supporting shelf which is overmolded to the plurality of terminals, the supporting shelf has a shelf body which is molded to the plurality of terminals, the wafer retaining portion protrudes from an outer surface of the shelf body, and the wafer retaining portion and the shelf body together clamp the spacing plate.

In some embodiments, the wafer retaining portion and the shelf body together form a Y-shape.

In some embodiments, the housing retain portion is a recessed groove, the wafer retaining portion is a protruding block which snaps to the recessed groove, the outer housing further comprises a spacing plate which is positioned at a side of the housing retain portion, the wafer further comprises an end segment, the wafer retaining portion and the end segment are spaced apart from each other along a vertical direction perpendicular to the inserting direction and together clamp the spacing plate.

In some embodiments, the outer housing further comprises at least one latching member, the latching member is positioned at any one of sides of the outer housing and is provided to latch and lock the wafer in the inserting direction.

In some embodiments, the wafer further comprises a plurality of terminals, a supporting shelf which is overmolded to the plurality of terminals, and a shielding member which locally covers the plurality of terminals, one of the supporting shelf and the shielding member is formed with a positioning hole, and the other of the supporting shelf and the shielding member has a positioning post which snaps to and interfere with the positioning hole.

Accordingly, a connector of the present disclosure comprises an outer housing and a wafer assembly. The outer housing is formed with a cavity and an upper port communicated with the cavity, the outer housing comprises a first housing retain portion and a second housing retain portion which are positioned in the cavity. The wafer assembly is provided to the cavity and comprises a first wafer, a second wafer, a third wafer and a fourth wafer which are mutually stacked and are retained, the first wafer comprises a first wafer retaining portion which is retained to the first housing retain portion, the fourth wafer comprises a second wafer retaining portion which is retained to the second housing retain portion, at least one of the first housing retain portion and the first wafer retaining portion extends along an inserting direction, at least one of the second housing retain portion and the second wafer retaining portion extends along the inserting direction.

In some embodiments, the first housing retain portion and the second housing retain portion each are a recessed groove which extends along the inserting direction and is communicated with the cavity, the first wafer retaining portion and the second wafer retaining portion each are a protruding block which snaps to the corresponding recessed groove.

In some embodiments, the outer housing further comprises a first spacing plate which is positioned between the first housing retain portion and the cavity, and a second spacing plate which is positioned between the second housing retain portion and the cavity, the first wafer and the fourth wafer each further comprises a plurality of terminals and a supporting shelf which is overmolded to the plurality of terminals, the supporting shelf has a shelf body which is molded to the plurality of terminals, the first wafer retaining portion protrudes from an outer surface of the shelf body of the first wafer, and the first wafer retaining portion and the shelf body of the first wafer together clamp the first spacing plate, the second wafer retaining portion protrudes from an outer surface of the shelf body of the fourth wafer, and the second wafer retaining portion and the shelf body of the fourth wafer together clamp the second spacing plate.

In some embodiments, the first wafer retaining portion and the shelf body of the first wafer together form a Y-shape, the second wafer retaining portion and the shelf body of the fourth wafer together form a Y-shape.

In some embodiments, the first housing retain portion and the second housing retain portion each are a recessed groove, the first wafer retaining portion and the second wafer retaining portion each are a protruding block which snaps to the corresponding recessed groove, the outer housing further comprises a first spacing plate which is positioned at a side of the first housing retain portion, and a second spacing plate which is positioned at a side of the second housing retain portion, the first wafer and the fourth wafer each further comprise an end segment, the first wafer retaining portion and the end segment of the first wafer are spaced apart from along a vertical direction perpendicular to the inserting direction and together clamp the first spacing plate, the second wafer retaining portion and the end segment of the fourth wafer are spaced apart from along the vertical direction and together clamp the second spacing plate.

In some embodiments, the outer housing further comprises at least one latching member, the latching member is positioned to any one of sides of the outer housing and is provided to latch and lock one of the first wafer, the second wafer, the third wafer and the fourth wafer in the inserting direction.

In some embodiments, one of the first wafer and the second wafer is formed with a retaining groove, and the other of the first wafer and the second wafer has a retaining block which snaps to the retaining groove, one of the third wafer and the fourth wafer is formed with a retaining groove, and the other of the third wafer and the fourth wafer has a retaining block which snaps to the retaining groove.

In some embodiments, the first wafer, the second wafer, the third wafer and the fourth wafer each comprise a plurality of terminals, and a shielding member which locally covers the plurality of terminals, one of the shielding member of the first wafer and the shielding member of the second wafer is formed with a retaining groove, and the other of the shielding member of the first wafer and the shielding member of the second wafer has a retaining block which snaps to the retaining groove, one of the shielding member of the third wafer and the shielding member of the fourth wafer is formed with a retaining groove, and the other of the shielding member of the third wafer and the shielding member of the fourth wafer has a retaining block which snaps to the retaining groove.

In some embodiments, the retaining block has a long block body and two snapping block bodies, a length direction of the long block body extends along the inserting direction, the two snapping block bodies respectively protrude from two long sides of the long block body and are respectively adjacent to two short sides of the long block body, the two snapping block bodies snap to the corresponding retaining groove.

In some embodiments, the second wafer has a first snapping member, the third wafer has a second snapping member which snaps to the first snapping member.

In some embodiments, the second wafer and the third wafer each comprises a plurality of terminals, and a supporting shelf which is overmolded to the plurality of terminals, the supporting shelf of the second wafer has a first snapping member, the supporting shelf of the third wafer has a second snapping member which snaps to the first snapping member.

In some embodiments, the first snapping member has at least one first snapping hook, the first snapping hook has a first hook portion which extends along the inserting direction, the second snapping member has at least one second snapping hook, the second snapping hook has a second hook portion which extends along the inserting direction and snaps to the first hook portion.

In some embodiments, the first snapping member has two first snapping hooks, the two first snapping hooks are oppositely provided along a horizontal direction perpendicular to the inserting direction and are spaced apart from each other, each first snapping hook further has a strengthening wall portion which is connected to a side of the first hook portion and extends along the inserting direction, the second snapping member has a strengthening block, and two second snapping hooks which respectively protrude from opposite sides of the strengthening block and are spaced apart from each other along the horizontal direction.

In some embodiments, the first wafer, the second wafer, the third wafer and the fourth wafer each comprise a plurality of terminals, a supporting shelf which is overmolded to the plurality of terminals, and a shielding member which locally covers the plurality of terminals, one of the supporting shelf and the shielding member is formed with a positioning hole, and the other of the supporting shelf and the shielding member has a positioning post which snaps to and interferes with the positioning hole.

In some embodiments, the outer housing comprises a main housing body, an upper protrude housing body which protrudes from the main housing body, extends along the inserting direction, and is formed with the upper port, and a strengthening bracket which is connected between a bottom end of the upper protrude housing body and the main housing body.

In some embodiments, the outer housing further is formed with a lower port which is communicated with the cavity, the outer housing further comprises a third housing retain portion and a fourth housing retain portion which are positioned in the cavity, the wafer assembly further comprises a fifth wafer, a sixth wafer, a seventh wafer and an eighth wafer which are mutually stacked and are retained, the fifth wafer comprises a third wafer retaining portion which is retained to the third housing retain portion, the eighth wafer comprises is a fourth wafer retaining portion which is retained to the fourth housing retain portion, at least one of the third housing retain portion and the third wafer retaining portion extends along the inserting direction, at least one of the fourth housing retain portion and the fourth wafer retaining portion extends along the inserting direction.

In some embodiments, the third housing retain portion and the fourth housing retain portion each are a recessed groove which extends along the inserting direction and is communicated with the cavity, the third wafer retaining portion and the fourth wafer retaining portion each are a protruding block which snaps to the corresponding recessed groove.

In some embodiments, the outer housing further comprises a third spacing plate which is positioned between the third housing retain portion and the cavity, and a fourth spacing plate which is positioned between the fourth housing retain portion and the cavity, the fifth wafer and the eighth wafer each further comprise a plurality of terminals, and a supporting shelf which is overmolded to the plurality of terminals, the supporting shelf has a shelf body which is molded to the plurality of terminals, the third wafer retaining portion protrudes from an outer surface of the shelf body of the fifth wafer, and the third wafer retaining portion and the shelf body of the fifth wafer together clamp the third spacing plate, the fourth wafer retaining portion protrudes from an outer surface of the shelf body of the eighth wafer, and the fourth wafer retaining portion and the shelf body of the eighth wafer together clamp the fourth spacing plate.

In some embodiments, the third wafer retaining portion and the shelf body of the fifth wafer together form a Y-shape, the fourth wafer retaining portion and the shelf body of the eighth wafer together form a Y-shape.

In some embodiments, the third housing retain portion and the fourth housing retain portion each are a recessed groove, the third wafer retaining portion and the fourth wafer retaining portion each are a protruding block which snaps to the corresponding recessed groove, the outer housing further comprises a third spacing plate which is positioned at a side of the third housing retain portion, and a fourth spacing plate which is positioned at a side of the fourth housing retain portion, the fifth wafer and the eighth wafer each further comprise an end segment, the third wafer retaining portion and the end segment of the fifth wafer are spaced apart from each other along a vertical direction perpendicular to the inserting direction and together clamp the third spacing plate, the fourth wafer retaining portion and the end segment of the eighth wafer are spaced apart from along the vertical direction and together clamp the fourth spacing plate.

In some embodiments, one of the seventh wafer and the eighth wafer is formed with a retaining groove, and the other of the seventh wafer and the eighth wafer has a retaining block which snaps to the retaining groove.

In some embodiments, the seventh wafer and the eighth wafer each comprise a plurality of terminals, and a shielding member which locally covers the plurality of terminals, one of the shielding member of the seventh wafer and the shielding member of the eighth wafer is formed with a retaining groove, and the other of the shielding member of the seventh wafer and the shielding member of the eighth wafer has a retaining block which snaps to the retaining groove.

In some embodiments, the retaining block has a long block body and two snapping block bodies, a length direction of the long block body extends along the inserting direction, the two snapping block bodies respectively protrude from two long sides of the long block body and are respectively adjacent to two short sides of the long block body, the two snapping block bodies snap to the corresponding retaining groove.

The present disclosure at least has the following effects: by that the first wafer retaining portion and the second wafer retaining portion are respectively retained to the first housing retain portion and the second housing retain portion, it can prevent the first wafer, the second wafer, the third wafer and the fourth wafer of the wafer assembly, which correspond to the upper port of the outer housing, from loosening relative to the outer housing in the vertical direction. By that the third wafer retaining portion and the fourth wafer retaining portion are respectively retained to the third housing retain portion and the fourth housing retain portion, it can prevent the fifth wafer, the sixth wafer, the seventh wafer and the eighth wafer of the wafer assembly, which correspond to the lower port of the outer housing, from loosening relative to the outer housing in the vertical direction. Therefore, the wafer assembly is capable of being firmly positioned in the cavity of the outer housing. When the two pluggable modules mate with the connector, the wafer assembly is capable of stably maintaining an electrically connecting state with the two pluggable modules which mate therewith so as to promote the electrical connecting performance.

### BRIEF DESCRIPTION OF THE DRAWINGS

Other features and effects of the present disclosure will be apparent from an embodiment with reference to the drawings, in which:

FIG. 1 is a perspective view of an embodiment of a connector of the present disclosure;

FIG. 2 is a perspective view of the embodiment viewed from another angle;

FIG. 3 is a cross sectional view taken along a line III-III of FIG. 1;

FIG. 4 is a perspective exploded view of the embodiment illustrating an assembling relationship among an outer housing, two side supporting plates, a supporting frame and a wafer assembly;

FIG. 5 is a perspective exploded view of the embodiment viewed from another angle;

FIG. 6 is a cross sectional view taken along a line VI-VI of FIG. 4;

FIG. 7 is a rear view of the outer housing of the embodiment;

FIG. 8 is an incomplete perspective exploded view of the wafer assembly of the embodiment illustrating an assembling relationship among a first wafer, a second wafer, a third wafer and a fourth wafer;

FIG. 9 is a perspective view of the first wafer of the embodiment;

FIG. 10 is an incomplete perspective view of the first wafer of the embodiment viewed from another angle;

FIG. 11 is an incomplete perspective view of the second wafer of the embodiment;

FIG. 12 is a bottom view of the second wafer of the embodiment;

FIG. 13 is an incomplete cross sectional view of the first wafer and the second wafer of the embodiment;

FIG. 14 is a perspective view of the third wafer of the embodiment;

FIG. 15 is an incomplete cross sectional view of the second wafer and the third wafer of the embodiment;

FIG. 16 is an incomplete cross sectional view taken along a line XVI-XVI of FIG. 15;

FIG. 17 is a top view of the third wafer of the embodiment;

FIG. 18 is a perspective view of the fourth wafer of the embodiment;

FIG. 19 is a cross sectional view of the third wafer and the fourth wafer of the embodiment;

FIG. 20 is an incomplete perspective exploded view of the wafer assembly of the embodiment illustrating an assembling relationship among a fifth wafer, a sixth wafer, a seventh wafer and an eighth wafer;

FIG. 21 is a perspective view of the fifth wafer of the embodiment; and

FIG. 22 is a cross sectional view of the seventh wafer and the eighth wafer of the embodiment.

### DETAILED DESCRIPTION

Before the present disclosure is described in detail, it is noted that the similar elements are indicated by the same reference numerals in the following description.

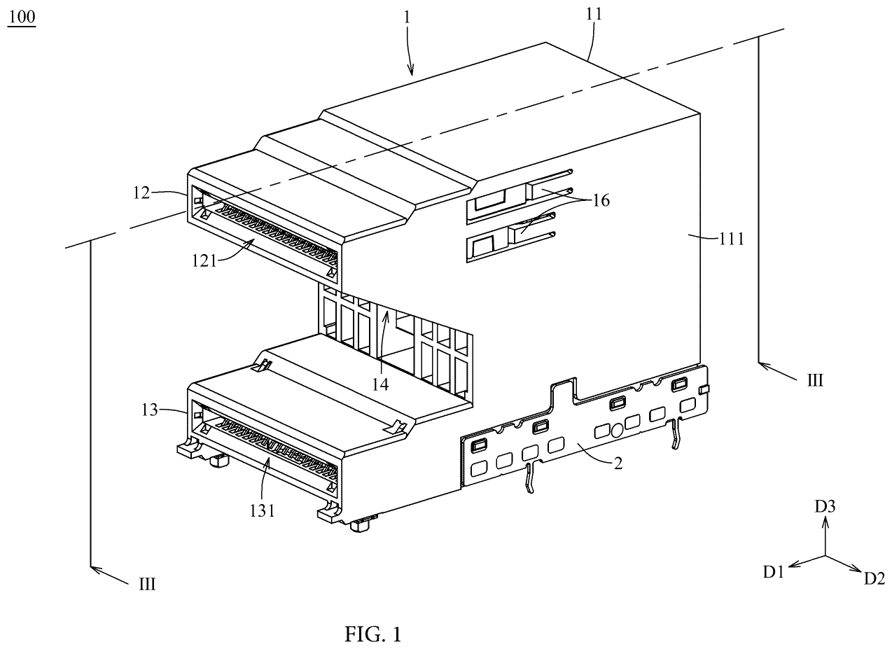

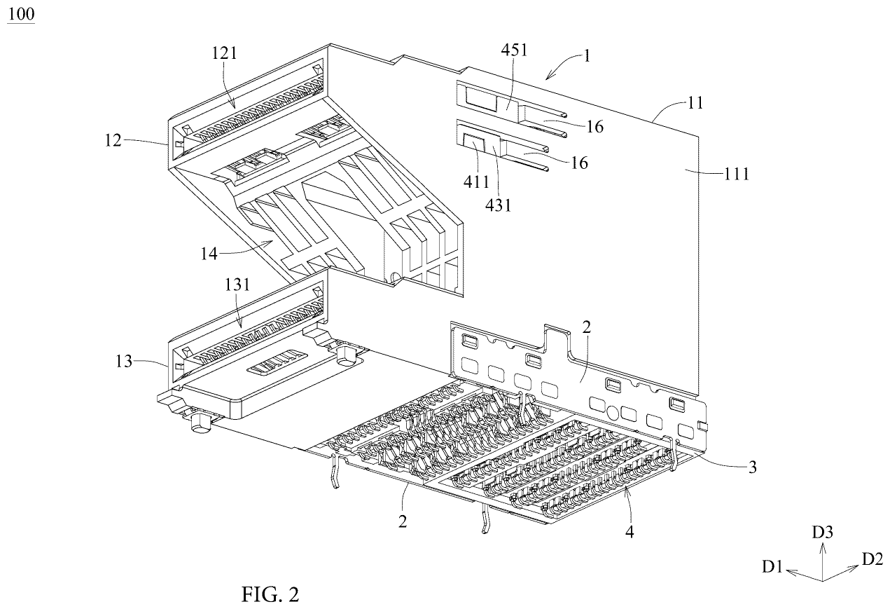

Referring to FIG. 1 and FIG. 2, an embodiment of a connector of the present disclosure 100 is adapted to allow two pluggable modules (not shown) to mate therewith. The connector 100 includes an outer housing 1, two side supporting plates 2, a supporting frame 3 and a wafer assembly 4.

For sake of convenience of the later description, in the connector 100, a first horizontal direction D1, a second horizontal direction D2 perpendicular to the first horizontal direction D1 and a vertical direction D3 perpendicular to the first horizontal direction D1 and the second horizontal direction D2 are defined. In the embodiment, the first horizontal direction D1 takes a front-rear direction as example, in FIG. 1, a direction to which an arrow points is front and a direction opposite to front is rear. The second horizontal direction D2 takes a left-right direction as example, in FIG. 1, a direction to which an arrow points is left and a direction opposite to left is right. The vertical direction D3 takes an up-down direction as example, in FIG. 1, a direction to which an arrow points is up and a direction opposite to up is down.

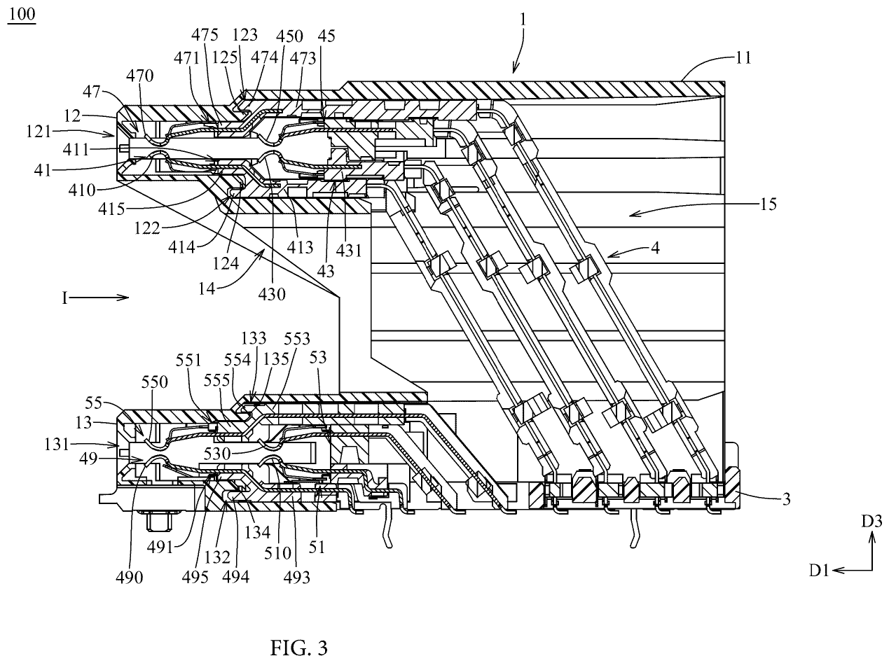

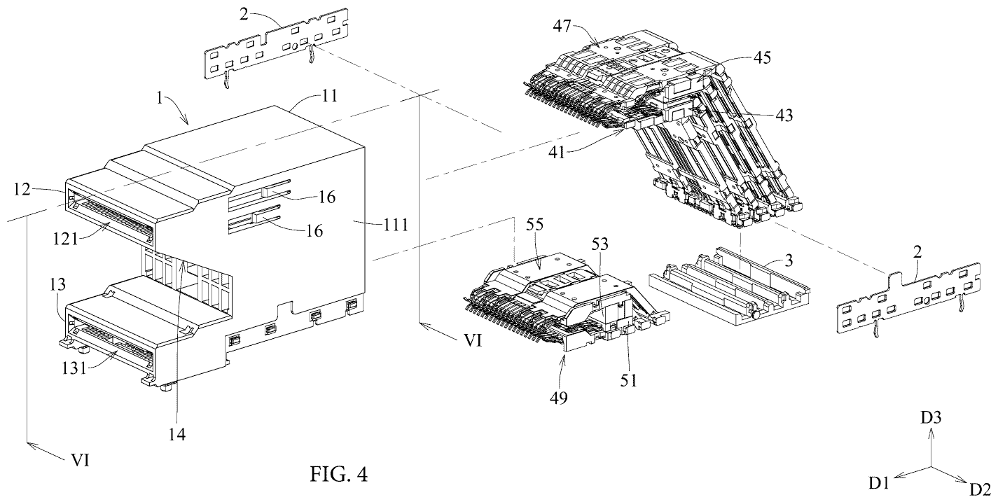

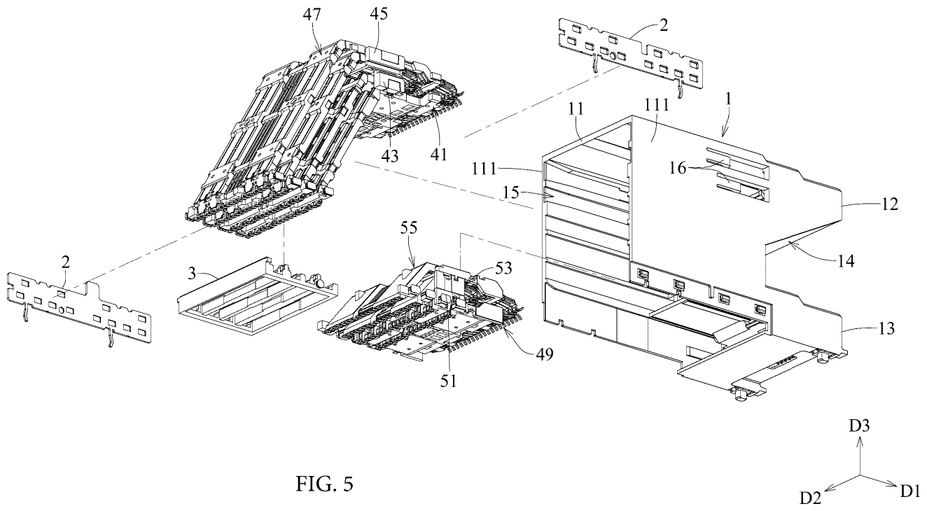

Referring to FIG. 2, FIG. 3, FIG. 4 and FIG. 5, the outer housing 1 is made from an insulative material, such as a plastic, and is used to allow the two pluggable modules to mate therewith along an inserting direction I which is parallel to the first horizontal direction D1. The outer housing 1 includes a main housing body 11, an upper protrude housing body 12 which protrudes from a front end of the main housing body 11 and extends along the inserting direction I, a lower protrude housing body 13 which protrudes from the front end of the main housing body 1, extends along the inserting direction I, is positioned below the upper protrude housing body 12, and is spaced apart from the upper protrude housing body 12, and a strengthening bracket 14. The main housing body 11, the upper protrude housing body 12 and the lower protrude housing body 13 together define a cavity 15 which is used to allow the wafer assembly 4 to be received therein. A rear end of the cavity 15 and a bottom end of the cavity 15 are opened. The upper protrude housing body 12 is formed with an upper port 121 which is communicated with the cavity 15 and is toward the front. The lower protrude housing body 13 is formed with a lower port 131 which is communicated with the cavity 15 and is toward the front. The two pluggable modules are capable of inserting into the cavity 15 respectively via the upper port 121 and the lower port 131. The strengthening bracket 14 is integrally connected between a bottom end of the upper protrude housing body 12 and a front end of the main housing body 11, is used to support the upper protrude housing body 12 so as to increase a structural strength of the upper protrude housing body 12. Therefore, when the pluggable module inserts into the cavity 15 via the upper port 121, it can reduce even prevent the upper protrude housing body 12 from bending deformation.

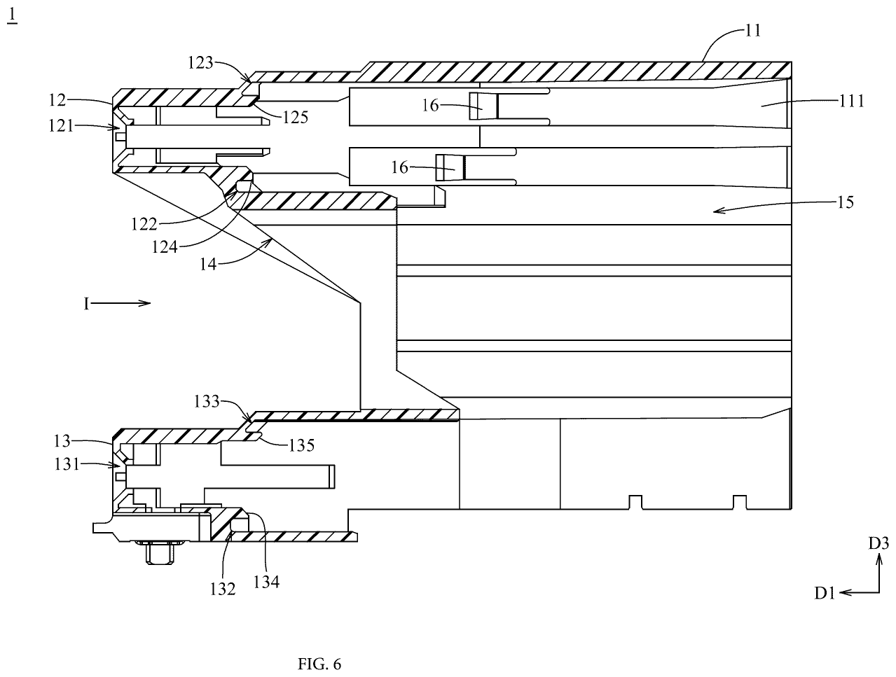

Referring to FIG. 3, FIG. 4, FIG. 5 and FIG. 6, the outer housing 1 further includes at least one latching member 16, the latching member 16 is positioned at any one of sides of the outer housing 1 and is provided to latch and lock the wafer assembly 4 in the inserting direction I, so as to prevent the wafer assembly 4 from moving rearwardly along the inserting direction I to in turn leave the cavity 15 of the outer housing 1. In the present embodiment, the main housing body 11 of the outer housing 1 has two side walls 111 which are spaced apart from each other along the second horizontal direction D2. The outer housing 1 includes two pairs of latching members 16 which are spaced apart from each other along the vertical direction D3. Each pair of latching members 16 are respectively provided to the two side walls 111. Each latching member 16 is an elastic latching arm which is integrally connected to the corresponding side wall 111 so as to latch and lock the wafer assembly 4.

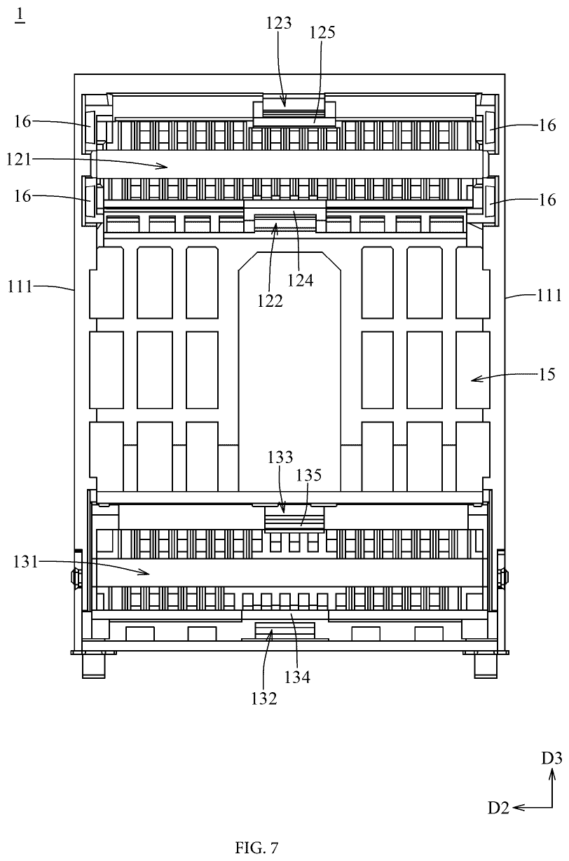

Referring to FIG. 3, FIG. 6 and FIG. 7, the upper protrude housing body 12 of the outer housing 1 has a first housing retain portion 122 and a second housing retain portion 123 which are positioned in the cavity 15. The second housing retain portion 123 is positioned above the first housing retain portion 122 along the vertical direction D3 and is spaced apart from the first housing retain portion 122. The lower protrude housing body 13 of The outer housing 1 has a third housing retain portion 132 and a fourth housing retain portion 133 which are positioned in the cavity 15. The fourth housing retain portion 133 is positioned above the third housing retain portion 132 along the vertical direction D3 and is spaced apart from the third housing retain portion 132. The first housing retain portion 122, the second housing retain portion 123, the third housing retain portion 132 and the fourth housing retain portion 133 are used to retain the wafer assembly 4, so as to prevent the wafer assembly 4 from loosening relative to the outer housing 1 in the vertical direction D3, so that the wafer assembly 4 is capable of being firmly positioned in the cavity 15 of the outer housing 1.

In the present embodiment, the first housing retain portion 122, the second housing retain portion 123, the third housing retain portion 132 and the fourth housing retain portion 133 each are a recessed groove which extends along the inserting direction I and is communicated with the cavity 15. Moreover, the upper protrude housing body 12 of the outer housing 1 further has a first spacing plate 124 which is positioned between the first housing retain portion 122 and the cavity 15, and a second spacing plate 125 which is positioned between the second housing retain portion 123 and the cavity 15. Here, the first spacing plate 124 is positioned at an upper side of the first housing retain portion 122 along the vertical direction D3, the second spacing plate 125 is positioned at a lower side of the second housing retain portion 123 along the vertical direction D3. The lower protrude housing body 13 of the outer housing 1 further has a third spacing plate 134 which is positioned between the third housing retain portion 132 and the cavity 15, and a fourth spacing plate 135 which is positioned between the fourth housing retain portion 133 and the cavity 15. Here, the third spacing plate 134 is positioned at an upper side of the third housing retain portion 132 along the vertical direction D3, the fourth spacing plate 135 is positioned at a lower side of the fourth housing retain portion 133 along the vertical direction D3.

Referring to FIG. 2, FIG. 4 and FIG. 5, the two side supporting plates 2 are respectively provided to the two side walls 111 of the outer housing 1 and are respectively adjacent to bottom ends of the two side walls 111. The two side supporting plates 2 are respectively provided to opposite sides of the wafer assembly 4, and are used to support the wafer assembly 4. The supporting frame 3 is provided between the two side supporting plates 2 and to a bottom end of the wafer assembly 4, and is used to support the wafer assembly 4.

Referring to FIG. 3, FIG. 4 and FIG. 5, the wafer assembly 4 includes a first wafer 41, a second wafer 43, a third wafer 45, a fourth wafer 47, a fifth wafer 49, a sixth wafer 51, a seventh wafer 53 and an eighth wafer 55. The first wafer 41, the second wafer 43, the third wafer 45 and the fourth wafer 47 are mutually stacked from down to up along the vertical direction D3 and are retained. The first wafer 41, the second wafer 43, the third wafer 45 and the fourth wafer 47 are provided between the two side supporting plates 2 and the supporting frame 3 and are supported by the two side supporting plates 2 and the supporting frame 3. The first wafer 41, the second wafer 43, the third wafer 45 and the fourth wafer 47 correspond to the upper port 121 of the outer housing 1, and are used to electrically connect the corresponding pluggable module. The fifth wafer 49, the sixth wafer 51, the seventh wafer 53 and the eighth wafer 55 are mutually stacked from down to up along the vertical direction D3 and are retained. The fifth wafer 49, the sixth wafer 51, the seventh wafer 53 and the eighth wafer 55 correspond to the lower port 131 of the outer housing 1, and are used to electrically connect the corresponding pluggable module.

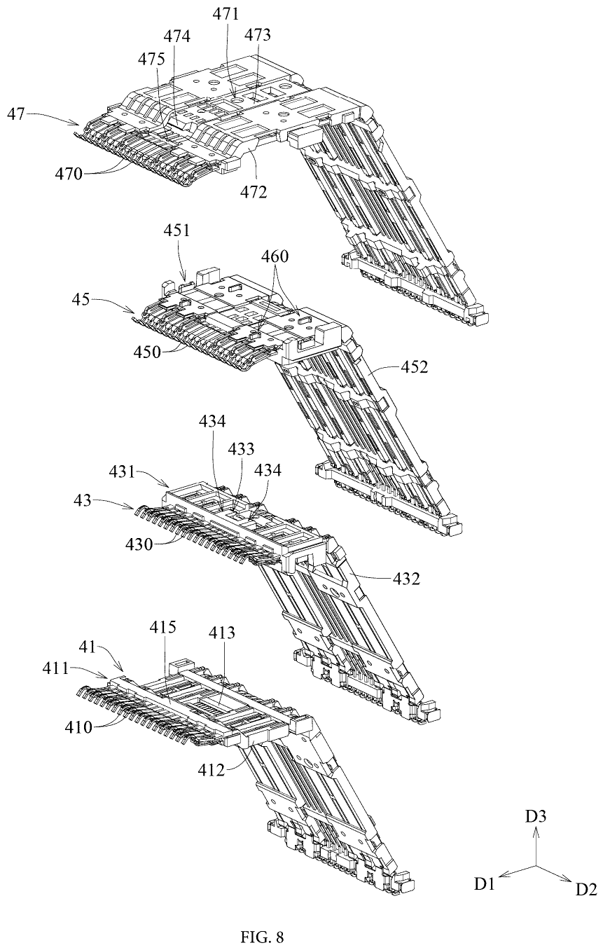

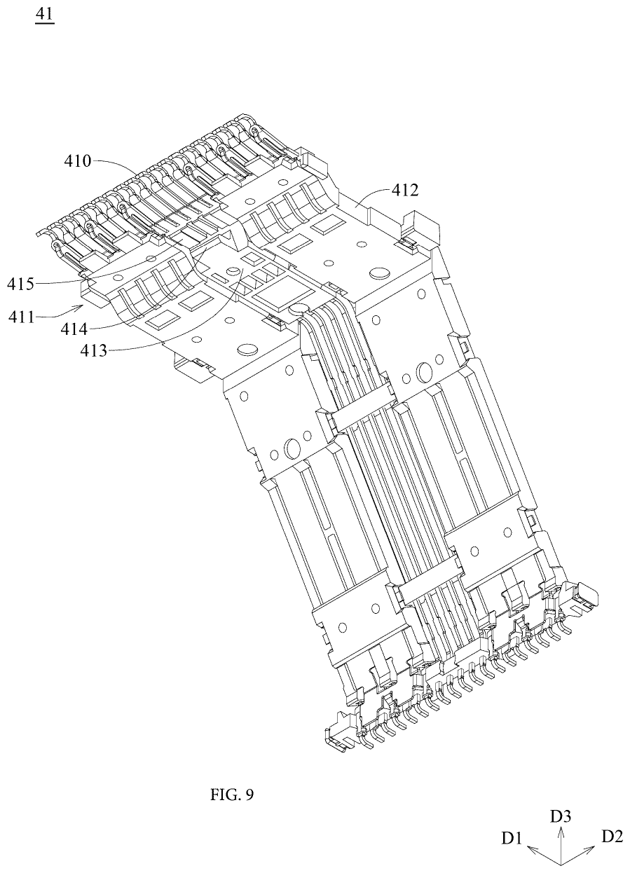

Referring to FIG. 3, FIG. 8 and FIG. 9, the first wafer 41 includes a plurality of terminals 410, a supporting shelf 411 which is overmolded to the plurality of terminals 410, and a shielding member 412 which locally covers the plurality of terminals 410. Each terminal 410 is in form of curved shape. The supporting shelf 411 is made from an insulative material, such as a plastic. The supporting shelf 411 has a shelf body 413 which is molded to the plurality of terminals 410 and is in form of curved shape, and a first wafer retaining portion 414 which is provided to the shelf body 413. The first wafer retaining portion 414 is retained to the first housing retain portion 122 of the outer housing 1. In the present embodiment, the first wafer retaining portion 414 is a protruding block which protrudes from an outer surface of the shelf body 413, extends along the inserting direction I, and snaps to the first housing retain portion 122. By that both the first wafer retaining portion 414 and the first housing retain portion 122 extend along the inserting direction I, a contact area between the first wafer retaining portion 414 and the outer housing 1 in the inserting direction I can be increased, so that firmness that the first wafer retaining portion 414 and the first housing retain portion 122 snap to each other can be promoted. It is noted that, in another implementing manner of the present embodiment, it also may be that at least one of the first housing retain portion 122 and the first wafer retaining portion 414 extends along the inserting direction I, so the present disclosure is not limited to that both the first housing retain portion 122 and the first wafer retaining portion 414 extend along the inserting direction I.

Moreover, the first wafer retaining portion 414 and the shelf body 413 together form a Y-shape. The shelf body 413 has an end segment 415, the end segment 415 is positioned above the first wafer retaining portion 414 along the vertical direction D3 and is spaced apart from the first wafer retaining portion 414, and the end segment 415 and the first wafer retaining portion 414 together clamp the first spacing plate 124. Therefore, it can prevent the supporting shelf 411 from moving or rotating up and down relative to the outer housing 1, so as to prevent the first wafer 41 from loosening relative to the outer housing 1 in the vertical direction D3.

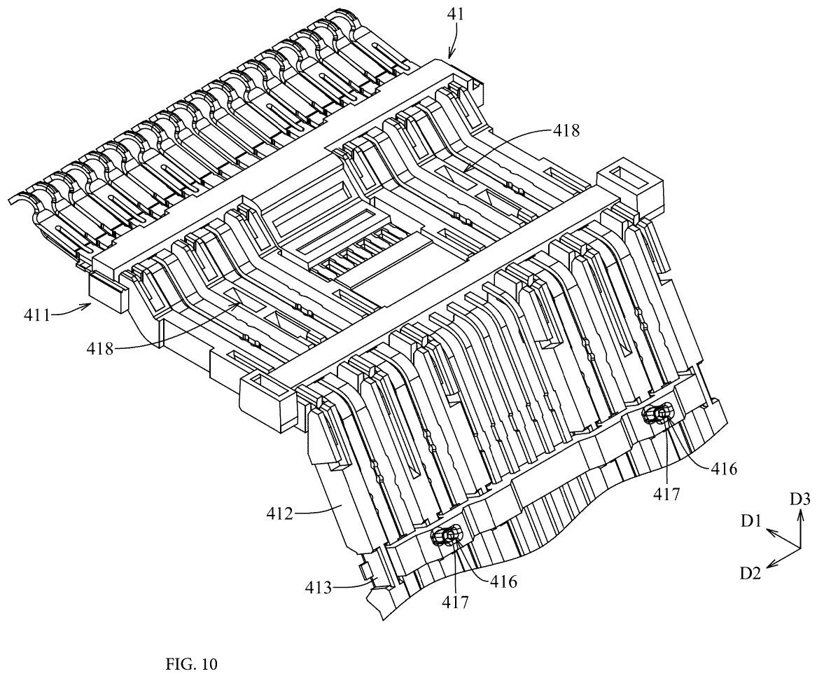

Referring to FIG. 10, the shelf body 413 of the supporting shelf 411 is formed with a plurality of positioning holes 416 which are arranged to be spaced apart from each other, the shielding member 412 has a plurality of positioning posts 417 which are arranged to be spaced apart from each other, the plurality of positioning posts 417 respectively snap to and interfere with the plurality of positioning holes 416. Therefore, it can prevent the shielding member 412 from shaking relative to the supporting shelf 411, so that the shielding member 412 is capable of being firmly positioned over the supporting shelf 411. It is noted that, in another implementing manner of the present embodiment, it also may be that the shielding member 412 is formed with a plurality of positioning holes but the shelf body 413 of the supporting shelf 411 has a plurality of positioning posts, so the present disclosure is not limited to the aforementioned manner. Moreover, the shielding member 412 is formed with a plurality of retaining grooves 418 which are arranged to be spaced apart from each other.

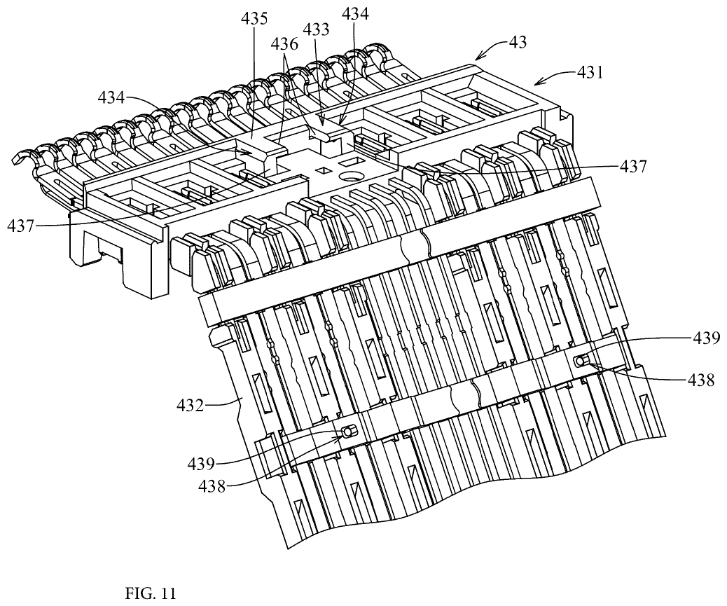

Referring to FIG. 2, FIG. 3, FIG. 8 and FIG. 11, the second wafer 43 includes a plurality of terminals 430, a supporting shelf 431 which is overmolded to the plurality of terminals 430, and a shielding member 432 which locally covers the plurality of terminals 430. Each terminal 430 is in form of curved shape. The supporting shelf 431 is made from an insulative material, such as a plastic, and is stacked on the supporting shelf 411 of the first wafer 41. A left side and a right side of the supporting shelf 431 are latched and locked by the corresponding pair of the latching members 16. The supporting shelf 431 has a first snapping member 433. The first snapping member 433 has two first snapping hooks 434, the two first snapping hooks 434 are oppositely provided along the second horizontal direction D2 and are spaced apart from each other. Each first snapping hooks 434 has a wall portion 435, a first hook portion 436 which is formed to a top end of the wall portion 435 and extends along the inserting direction I, and a strengthening wall portion 437 which is connected to an outer side the wall portion 435 and an outer side of the first hook portion 436 and extends along the inserting direction I. By the design of the strengthening wall portion 437, each first snapping hook 434 can increase a structural strength of the first hook portion 436 so as to prevent the first hook portion 436 from being deformed when the first hook portion 436 is subjected to a force.

The supporting shelf 431 is formed with a plurality of positioning holes 438 which are arranged to be spaced apart from each other, the shielding member 432 has a plurality of positioning posts 439 which are arranged to be spaced apart from each other, the plurality of positioning posts 439 respectively snap to and interfere with the plurality of positioning holes 438. Therefore, it can prevent the shielding member 432 from shaking relative to the supporting shelf 431, so that the shielding member 432 is capable of being firmly positioned over the supporting shelf 431. It is noted that, in another implementing manner of the present embodiment, it also may be that the shielding member 432 is formed with a plurality of positioning holes but the supporting shelf 431 has a plurality of positioning posts, so the present disclosure is not limited to the aforementioned manner.

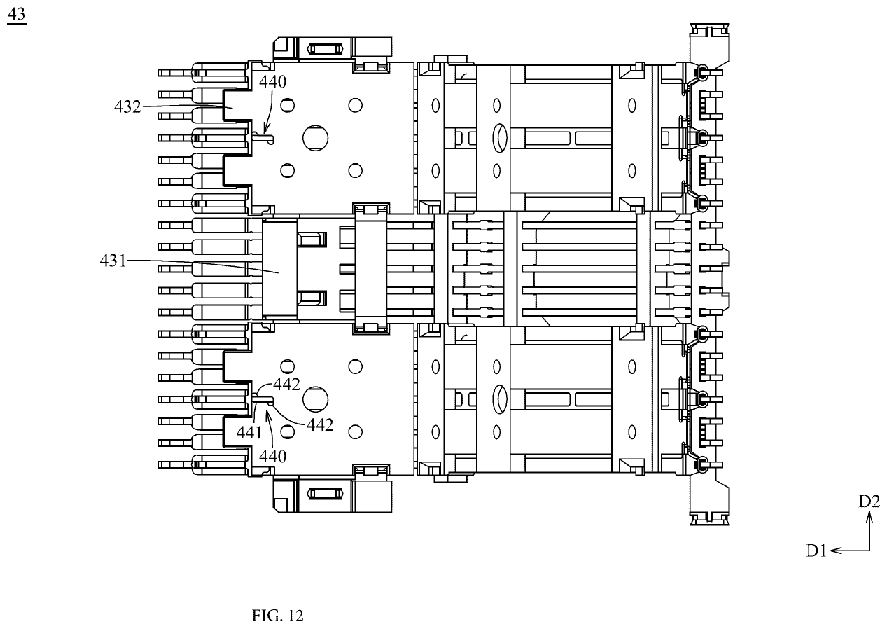

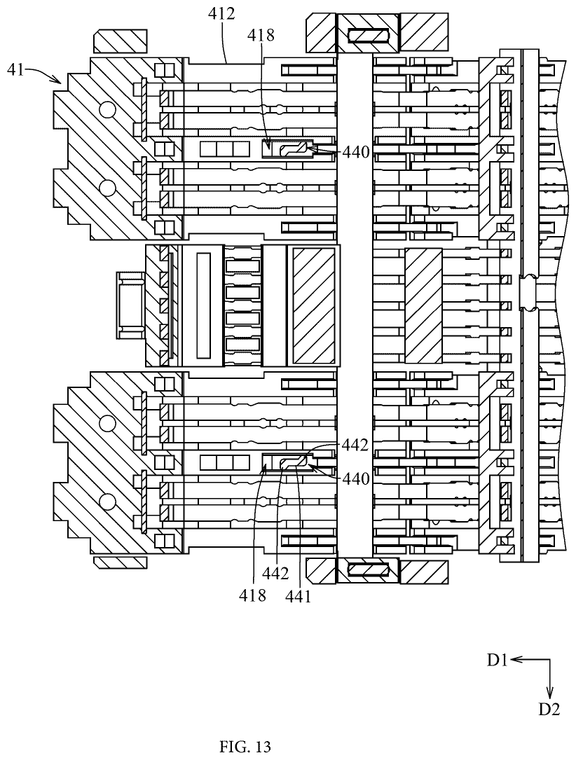

Referring to FIG. 12 and FIG. 13, the second wafer 43 of the shielding member 432 has a plurality of retaining blocks 440 which are arranged to be spaced apart from each other, the plurality of retaining blocks 440 respectively snap to the plurality of retaining grooves 418 of the shielding member 412 of the first wafer 41. Therefore, the shielding member 432 of the second wafer 43 is capable of being firmly positioned to the shielding member 412 of the first wafer 41, so that a better shielding effect can be obtained. Specifically, each retaining block 440 has a long block body 441 and two snapping block bodies 442. A length direction of the long block body 441 extends along the inserting direction I (as shown in FIG. 3). The two snapping block bodies 442 respectively protrude from two long sides of the long block body 441 and are respectively adjacent to two short sides of the long block body 441. Each retaining block 440 snaps to the corresponding retaining groove 418 by the two snapping block bodies 442. Therefore, besides that the retaining block 440 can firmly snaps to the corresponding retaining groove 418, an effect that a material molding the retaining block 440 is saved can be further attained. It is noted that, in another implementing manner of the present embodiment, it also may be that the shielding member 412 of the first wafer 41 has a plurality of retaining blocks but the shielding member 432 of the second wafer 43 forms a plurality of retaining grooves which respectively allow the plurality of retaining blocks to snap thereto, so the present disclosure is not limited to the aforementioned manner.

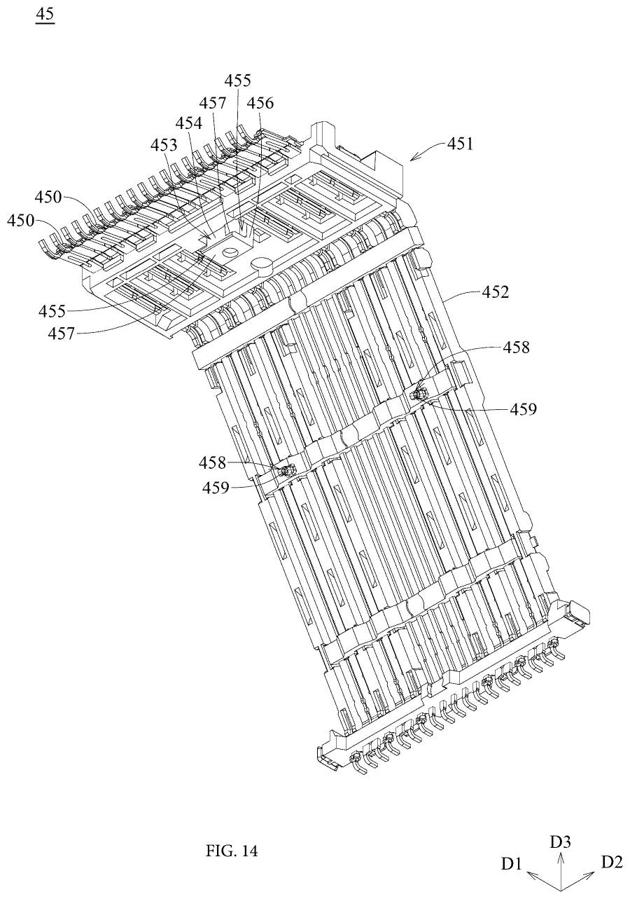

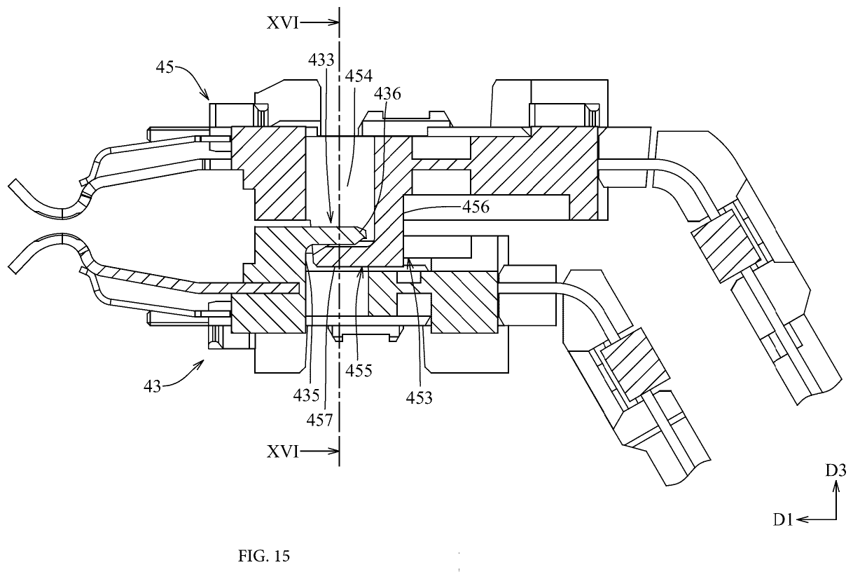

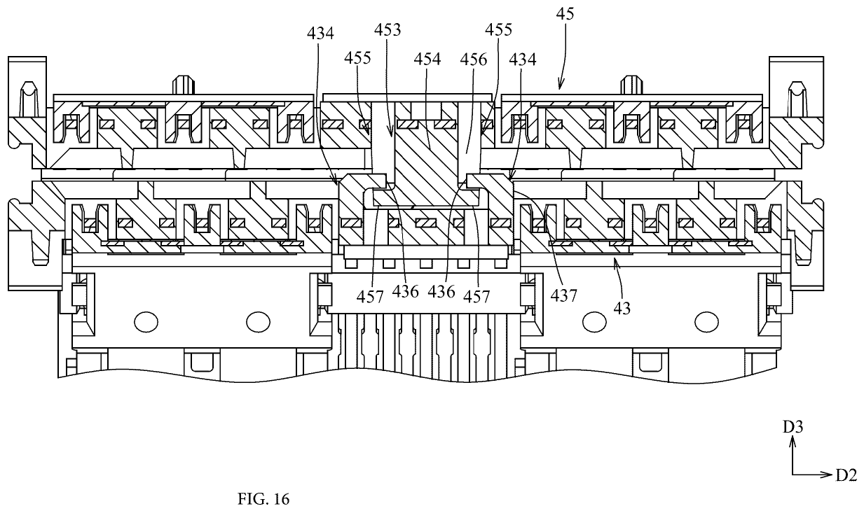

Referring to FIG. 8, FIG. 14, FIG. 15 and FIG. 16, the third wafer 45 includes a plurality of terminals 450, a supporting shelf 451 which is overmolded to the plurality of terminals 450, and a shielding member 452 which locally covers the plurality of terminals 450. Each terminal 450 is in form of curved shape. The supporting shelf 451 is made from an insulative material, such as a plastic, and is stacked on the supporting shelf 431 of the second wafer 43. A left side and a right side of the supporting shelf 451 are latched and locked by the corresponding pair of the latching members 16 (as shown in FIG. 2). The supporting shelf 451 has a second snapping member 453 which snaps to the first snapping member 433 of the second wafer 43. The second snapping member 453 has a strengthening block 454, and two second snapping hooks 455 which respectively protrude from opposite sides of the strengthening block 454 and are spaced apart from each other along the second horizontal direction D2. Each second snapping hook 455 has an arm portion 456 which extends along the vertical direction D3, and a second hook portion 457 which is formed to a bottom end of the arm portion 456 and extends along the inserting direction I (as shown in FIG. 3). The second hook portion 457 snaps to a bottom end of the first hook portion 436 of the corresponding first snapping hook 434. Therefore, a contact normal force can be increased, so that the supporting shelf 451 of the third wafer 45 is capable of being firmly positioned on the supporting shelf 431 of the second wafer 43. By that the strengthening block 454 is connected between the two second snapping hooks 455, structural strengths of the two second snapping hooks 455 can be increased, so as to prevent the two second snapping hooks 455 from being deformed when the two second snapping hooks 455 are subjected to a force. By that the number of the first snapping hooks 434 of the first snapping member 433 and the number of the second snapping hook 455 of the second snapping member 453 each are two, so that a contact area that the first snapping member 433 and the second snapping member 453 snap to each other is large, stability of snapping can be promoted.

It is noted that, in another implementing manner of the present embodiment, the number of the first snapping hook 434 of the first snapping member 433 and the number of the second snapping hook 455 of the second snapping member 453 each may be set as one as desired, and are not limited to the number disclosed by the present embodiment.

Referring to FIG. 14, the supporting shelf 451 is formed with a plurality of positioning holes 458 which are arranged to be spaced apart from each other, the shielding member 452 has a plurality of positioning posts 459 which are arranged to be spaced apart from each other, the plurality of positioning posts 459 respectively snap to and interfere with the plurality of positioning holes 458. Therefore, it can prevent the shielding member 452 from shaking relative to the supporting shelf 451, so that the shielding member 452 is capable of being firmly positioned over the supporting shelf 451. It is noted that, in another implementing manner of the present embodiment, it also may be that the shielding member 452 is formed with a plurality of positioning holes but the supporting shelf 451 has a plurality of positioning posts, so the present disclosure is not limited to the aforementioned manner.

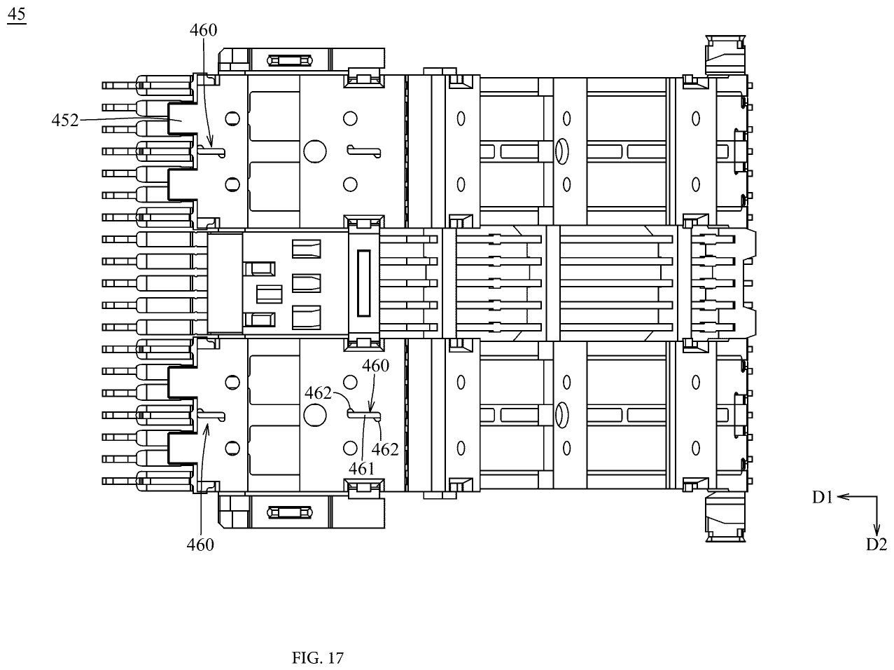

Referring to FIG. 8 and FIG. 17, the shielding member 452 of the third wafer 45 has a plurality of retaining blocks 460 which are arranged to be spaced apart from each other. Specifically, each retaining block 460 has a long block body 461 and two snapping block bodies 462. A length direction of the long block body 461 extends along the inserting direction I (as shown in FIG. 3). The two snapping block bodies 462 respectively protrude from two long sides of the long block body 461 and are respectively adjacent to two short sides of the long block body 461. Therefore, an effect that a material molding the retaining block 460 is saved can be attained.

Referring to FIG. 3 and FIG. 8, the fourth wafer 47 includes a plurality of terminals 470, a supporting shelf 471 which is overmolded to the plurality of terminals 470, and a shielding member 472 which locally covers the plurality of terminals 470. Each terminal 470 is in form of curved shape. The supporting shelf 471 is made from an insulative material, such as a plastic. The supporting shelf 471 has a shelf body 473 which is molded to the plurality of terminals 470 and is in form of curved shape, and a second wafer retaining portion 474 which is provided to the shelf body 473. The second wafer retaining portion 474 is retained to the second housing retain portion 123 of the outer housing 1. In the present embodiment, the second wafer retaining portion 474 is a protruding block which protrudes from an outer surface of the shelf body 473, extends along the inserting direction I, and snaps to the second housing retain portion 123. By that both the second wafer retaining portion 474 and the second housing retain portion 123 extend along the inserting direction I, an contact area between the second wafer retaining portion 474 and the outer housing 1 in the inserting direction I can be increased, so that firmness that the second wafer retaining portion 474 and the second housing retain portion 123 snap to each other can be promoted. It is noted that, in another implementing manner of the present embodiment, it also may be that at least one of the second housing retain portion 123 and the second wafer retaining portion 474 extends along the inserting direction I, so the present disclosure is not limited to that both the second housing retain portion 123 and the second wafer retaining portion 474 extend along the inserting direction I.

Moreover, the second wafer retaining portion 474 and the shelf body 473 together form a Y-shape. The shelf body 473 has an end segment 475, the end segment 475 is positioned below the second wafer retaining portion 474 along the vertical direction D3 and is spaced apart from the second wafer retaining portion 474, and the end segment 475 and the second wafer retaining portion 474 together clamp the second spacing plate 125. Therefore, it can prevent the supporting shelf 471 from moving or rotating up and down relative to the outer housing 1, so as to prevent the fourth wafer 47 from loosening relative to the outer housing 1 in the vertical direction D3.

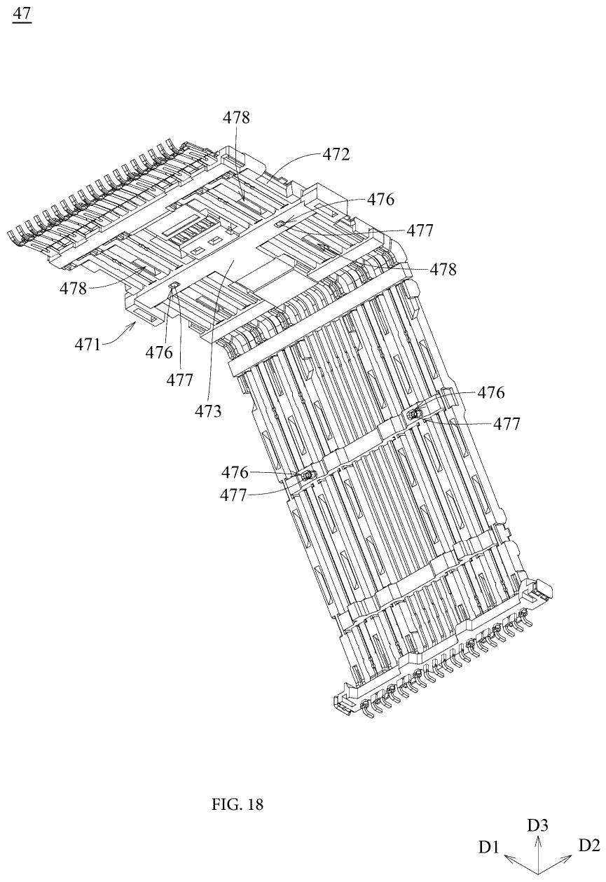

Referring to FIG. 18, the shelf body 473 of the supporting shelf 471 is formed with a plurality of positioning holes 476 which are arranged to be spaced apart from each other, the shielding member 472 has a plurality of positioning posts 477 which are arranged to be spaced apart from each other, the plurality of positioning posts 477 respectively snap to and interfere with the plurality of positioning holes 476. Therefore, it can prevent the shielding member 472 from shaking relative to the supporting shelf 471, so that the shielding member 472 is capable of being firmly positioned over the supporting shelf 471. It is noted that, in another implementing manner of the present embodiment, it also may be that the shielding member 472 is formed with a plurality of positioning holes but the shelf body 473 of the supporting shelf 471 has a plurality of positioning posts, so the present disclosure is not limited to the aforementioned manner.

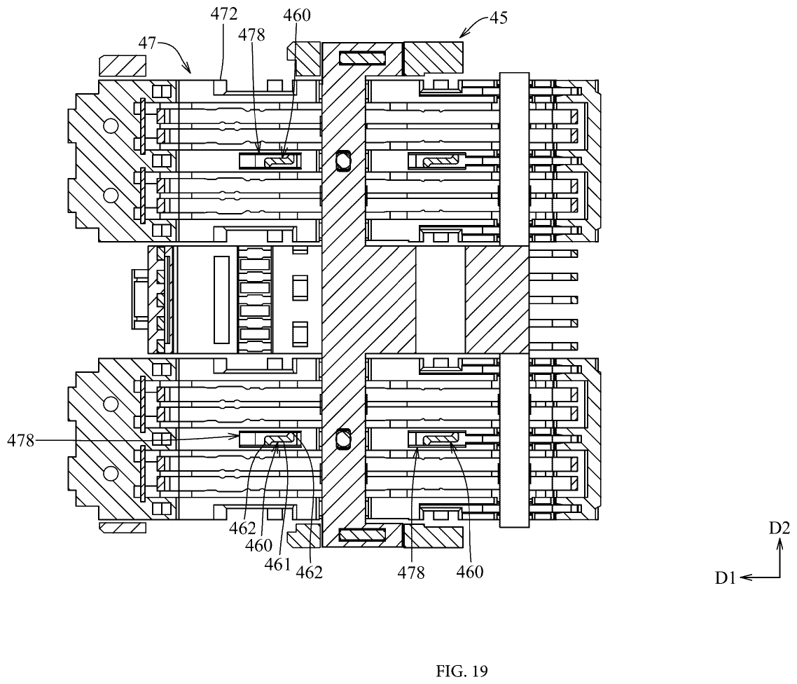

Referring to FIG. 8, FIG. 18 and FIG. 19, the shielding member 472 is formed with a plurality of retaining grooves 478 which are arranged to be spaced apart from each other. The plurality of retaining grooves 478 respectively allow the plurality of retaining blocks 460 of the third wafer 45 to snap thereto. Each retaining block 460 firmly snaps to the corresponding retaining groove 478 by the two snapping block bodies 462. Therefore, the shielding member 472 of the fourth wafer 47 is capable of being firmly positioned to the shielding member 452 of the third wafer 45, so that a better shielding effect can be obtained. It is noted that, in another implementing manner of the present embodiment, it also may be that the shielding member 472 of the fourth wafer 47 has a plurality of retaining blocks but the shielding member 452 of the third wafer 45 forms a plurality of retaining grooves which respectively allow the plurality of retaining blocks to snap thereto, so the present disclosure is not limited to the aforementioned manner.

Referring to FIG. 2 and FIG. 3, although that the two pairs of latching members 16 of the outer housing 1 respectively latch and lock the supporting shelf 431 of the second wafer 43 and the supporting shelf 451 of the third wafer 45 is taken as example for description, it may be that the two pairs of latching members 16 respectively latch and lock the supporting shelf 411 of the first wafer 41 and the supporting shelf 471 of the fourth wafer 47 as desired, so the present disclosure is not limited to the aforementioned manner.

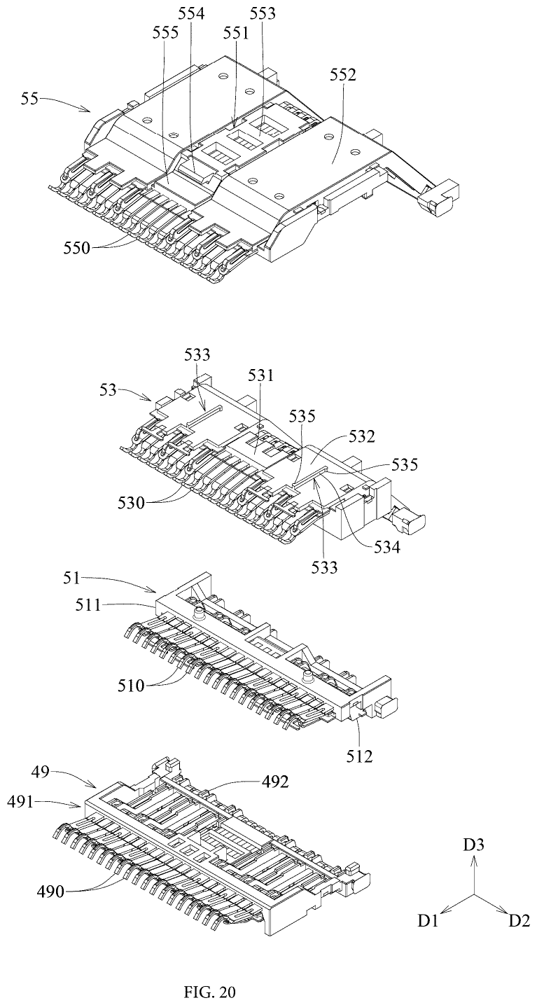

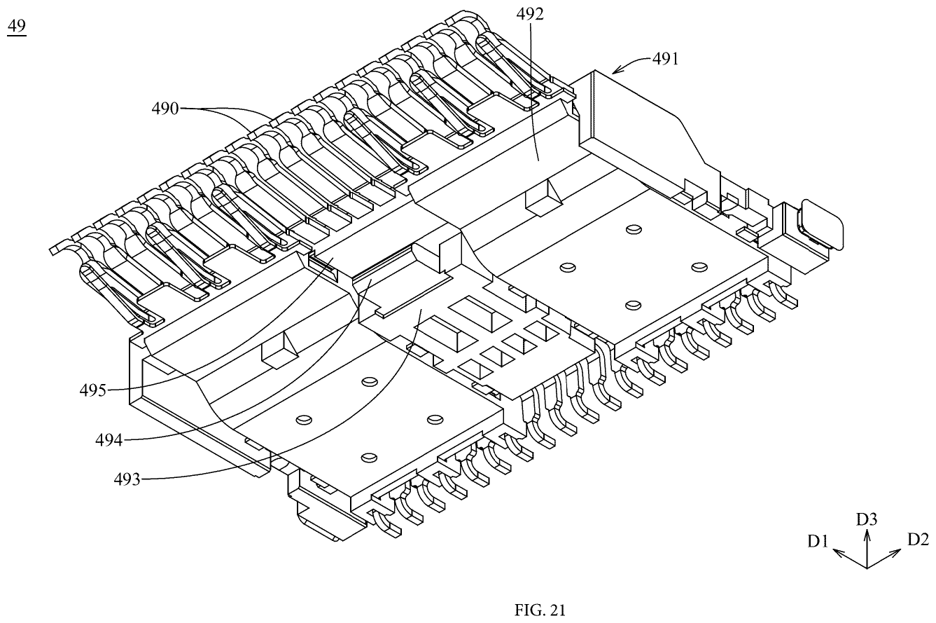

Referring to FIG. 3, FIG. 20 and FIG. 21, the fifth wafer 49 includes a plurality of terminals 490, a supporting shelf 491 which is overmolded to the plurality of terminals 490, and a shielding member 492 which locally covers the plurality of terminals 490. The supporting shelf 491 is made from an insulative material, such as a plastic. The supporting shelf 491 has a shelf body 493 which is molded to the plurality of terminals 490, and a third wafer retaining portion 494 which is provided to the shelf body 493. The third wafer retaining portion 494 is retained to the third housing retain portion 132 of the outer housing 1. In the present embodiment, the third wafer retaining portion 494 is a protruding block which protrudes from an outer surface of the shelf body 493, extends along the inserting direction I, and snaps to the third housing retain portion 132. By that both the third wafer retaining portion 494 and the third housing retain portion 132 extend along the inserting direction I, a contact area between the third wafer retaining portion 494 and the outer housing 1 in the inserting direction I can be increased, so that firmness that the third wafer retaining portion 494 and the third housing retain portion 132 snap to each other can be promoted. It is noted that, in another implementing manner of the present embodiment, it also may be that at least one of the third housing retain portion 132 and the third wafer retaining portion 494 extends along the inserting direction I, so the present disclosure is not limited to that both the third housing retain portion 132 and the third wafer retaining portion 494 extend along the inserting direction I.

Moreover, the third wafer retaining portion 494 and the shelf body 493 together form a Y-shape. The shelf body 493 has an end segment 495, the end segment 495 is positioned above the third wafer retaining portion 494 along the vertical direction D3 and is spaced apart from the third wafer retaining portion 494, and the end segment 495 and the third wafer retaining portion 494 together clamp the third spacing plate 134. Therefore, it can prevent the supporting shelf 491 from moving or rotating up and down relative to the outer housing 1, so as to prevent the fifth wafer 49 from loosening relative to the outer housing 1 in the vertical direction D3.

Referring to FIG. 3 and FIG. 20, the sixth wafer 51 includes a plurality of terminals 510, a supporting shelf 511 which is overmolded to the plurality of terminals 510, and a shielding member 512 which locally covers the plurality of terminals 510. The supporting shelf 511 is made from an insulative material, such as a plastic, and is stacked on the supporting shelf 491 of the fifth wafer 49.

The seventh wafer 53 includes a plurality of terminals 530, a supporting shelf 531 which is overmolded to the plurality of terminals 530, and a shielding member 532 which locally covers the plurality of terminals 530. Each terminal 530 is in form of curved shape. The supporting shelf 531 is made from an insulative material, such as a plastic, and is stacked on the supporting shelf 511 of the sixth wafer 51. The shielding member 532 has a plurality of retaining blocks 533 which are arranged to be spaced apart from each other. Specifically, each retaining block 533 has a long block body 534 and two snapping block bodies 535. A length direction of the long block body 534 extends along the inserting direction I (as shown in FIG. 3). The two snapping block bodies 535 respectively protrude from two long sides of the long block body 534 and are respectively adjacent to two short sides of the long block body 534. Therefore, an effect that a material molding the retaining block 533 is saved can be attained.

The eighth wafer 55 includes a plurality of terminals 550, a supporting shelf 551 which is overmolded to the plurality of terminals 550, and a shielding member 552 which locally covers the plurality of terminals 550. Each terminal 550 is in form of curved shape. The supporting shelf 551 is made from an insulative material, such as a plastic. The supporting shelf 551 has a shelf body 553 which is molded to the plurality of terminals 550 and is in form of curved shape, and a fourth wafer retaining portion 554 which is provided to the shelf body 553. The fourth wafer retaining portion 554 is retained to the fourth housing retain portion 133 of the outer housing 1. In the present embodiment, the fourth wafer retaining portion 554 is a protruding block which protrudes from an outer surface of the shelf body 553, extends along the inserting direction I, and snaps to the fourth housing retain portion 133. By that both the fourth wafer retaining portion 554 and the fourth housing retain portion 133 extend along the inserting direction I, a contact area between the fourth wafer retaining portion 554 and the outer housing 1 in the inserting direction I can be increased, so that firmness that the fourth wafer retaining portion 554 and the fourth housing retain portion 133 snap to each other can be promoted. It is noted that, in another implementing manner of the present embodiment, it also may be that at least one of the fourth housing retain portion 133 and the fourth wafer retaining portion 554 extends along the inserting direction I, so the present disclosure is not limited to that both the fourth housing retain portion 133 and the fourth wafer retaining portion 554 extend along the inserting direction I.

Moreover, the fourth wafer retaining portion 554 and the shelf body 553 together form a Y-shape. The shelf body 553 has an end segment 555, the end segment 555 is positioned below the fourth wafer retaining portion 554 along the vertical direction D3 and is spaced apart from the fourth wafer retaining portion 554, and the end segment 555 and the fourth wafer retaining portion 554 together clamp the fourth spacing plate 135. Therefore, it can prevent the supporting shelf 551 from moving or rotating up and down relative to the outer housing 1, so as to prevent the eighth wafer 55 from loosening relative to the outer housing 1 in the vertical direction D3.

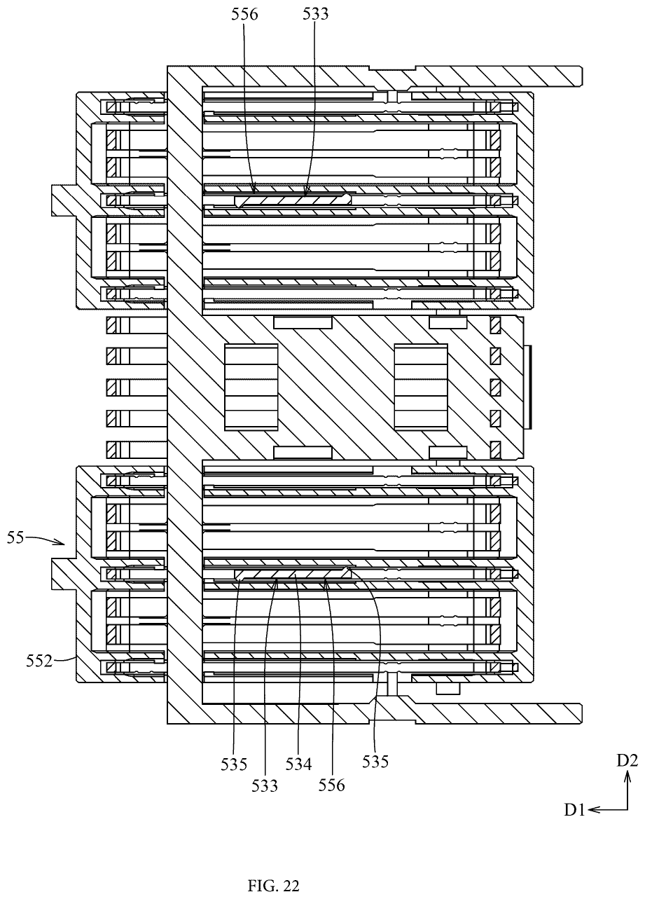

Referring to FIG. 20 and FIG. 22, the shielding member 552 is formed with a plurality of retaining grooves 556 which are arranged to be spaced apart from each other, the plurality of retaining grooves 556 respectively allow the plurality of retaining blocks 533 of the seventh wafer 53 to snap thereto. Each retaining block 533 firmly snaps to the corresponding retaining groove 556 by the two snapping block bodies 535. Therefore, the shielding member 552 of the eighth wafer 55 is capable of being firmly positioned to the shielding member 532 of the seventh wafer 53, so that a better shielding effect can be obtained. It is noted that, in another implementing manner of the present embodiment, it also may be that the shielding member 552 of the eighth wafer 55 has a plurality of retaining blocks but the shielding member 532 of the seventh wafer 53 form a plurality of retaining grooves which respectively allow the plurality of retaining blocks to snap thereto, so the present disclosure is not limited to the aforementioned manner.

In conclusion, in the connector 100 of the present embodiment, by that the first wafer retaining portion 414 and the second wafer retaining portion 474 are respectively retained to the first housing retain portion 122 and the second housing retain portion 123, it can prevent the first wafer 41, the second wafer 43, the third wafer 45 and the fourth wafer 47 of the wafer assembly 4, which correspond to the upper port 121 of the outer housing 1, from loosening relative to the outer housing 1 in the vertical direction D3. By that the third wafer retaining portion 494 and the fourth wafer retaining portion 554 are respectively retained to the third housing retain portion 132 and the fourth housing retain portion 133, it can prevent the fifth wafer 49, the sixth wafer 51, the seventh wafer 53 and the eighth wafer 55 of the wafer assembly 4, which correspond to the lower port 131 of the outer housing 1, from loosening relative to the outer housing 1 in the vertical direction D3. Therefore, the wafer assembly 4 is capable of being firmly positioned in the cavity 15 of the outer housing 1. When the two pluggable modules mate with the connector 100, the wafer assembly 4 is capable of stably maintaining an electrically connecting state with the two pluggable modules which mate therewith so as to promote the electrical connecting performance, so the object of the present disclosure can be indeed achieved.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

What is claimed is:

1. A connector comprising:
an outer housing which is formed with a cavity and a port communicated with the cavity, the outer housing comprising a housing retain portion which is positioned in the cavity; and
a wafer which is provided to the cavity and comprises a wafer retaining portion retained to the housing retain portion, at least one of the housing retain portion and the wafer retaining portion extending along an inserting direction.

2. The connector of claim 1, wherein
the housing retain portion is a recessed groove which extends along the inserting direction and is communicated with the cavity,
the wafer retaining portion is a protruding block which snaps to the recessed groove.

3. The connector of claim 2, wherein
the outer housing further comprises a spacing plate which is positioned between the housing retain portion and the cavity,
the wafer further comprises a plurality of terminals and a supporting shelf which is overmolded to the plurality of terminals,
the supporting shelf has a shelf body which is molded to the plurality of terminals,
the wafer retaining portion protrudes from an outer surface of the shelf body, and the wafer retaining portion and the shelf body together clamp the spacing plate.

4. The connector of claim 3, wherein
the wafer retaining portion and the shelf body together form a Y-shape.

5. The connector of claim 1, wherein
the housing retain portion is a recessed groove,
the wafer retaining portion is a protruding block which snaps to the recessed groove,
the outer housing further comprises a spacing plate which is positioned at a side of the housing retain portion,
the wafer further comprises an end segment,
the wafer retaining portion and the end segment are spaced apart from each other along a vertical direction perpendicular to the inserting direction and together clamp the spacing plate.

6. The connector of claim 1, wherein
the outer housing further comprises at least one latching member,
the latching member is positioned at any one of sides of the outer housing and is provided to latch and lock the wafer in the inserting direction.

7. The connector of claim 1, wherein
the wafer further comprises a plurality of terminals, a supporting shelf which is overmolded to the plurality of terminals, and a shielding member which locally covers the plurality of terminals,
one of the supporting shelf and the shielding member is formed with a positioning hole, and the other of the supporting shelf and the shielding member has a positioning post which snaps to and interfere with the positioning hole.

8. A connector comprising:
an outer housing which is formed with a cavity and an upper port communicated with the cavity, the outer housing comprising a first housing retain portion and a second housing retain portion which are positioned in the cavity; and
a wafer assembly provided to the cavity and comprising a first wafer, a second wafer, a third wafer and a fourth wafer which are mutually stacked and are retained, the first wafer comprising a first wafer retaining portion which is retained to the first housing retain portion, the fourth wafer comprising a second wafer retaining portion which is retained to the second housing retain portion, at least one of the first housing retain portion and the first wafer retaining portion extending along an inserting direction, at least one of the second housing retain portion and the second wafer retaining portion extending along the inserting direction.

9. The connector of claim 8, wherein
the first housing retain portion and the second housing retain portion each are a recessed groove which extends along the inserting direction and is communicated with the cavity,
the first wafer retaining portion and the second wafer retaining portion each are a protruding block which snaps to the corresponding recessed groove.

10. The connector of claim 9, wherein
the outer housing further comprises a first spacing plate which is positioned between the first housing retain portion and the cavity, and a second spacing plate which is positioned between the second housing retain portion and the cavity,
the first wafer and the fourth wafer each further comprises a plurality of terminals and a supporting shelf which is overmolded to the plurality of terminals, the supporting shelf has a shelf body which is molded to the plurality of terminals,
the first wafer retaining portion protrudes from an outer surface of the shelf body of the first wafer, and the first wafer retaining portion and the shelf body of the first wafer together clamp the first spacing plate,
the second wafer retaining portion protrudes from an outer surface of the shelf body of the fourth wafer, and the second wafer retaining portion and the shelf body of the fourth wafer together clamp the second spacing plate.

11. The connector of claim 10, wherein
the first wafer retaining portion and the shelf body of the first wafer together form a Y-shape,
the second wafer retaining portion and the shelf body of the fourth wafer together form a Y-shape.

12. The connector of claim 8, wherein
the first housing retain portion and the second housing retain portion each are a recessed groove,
the first wafer retaining portion and the second wafer retaining portion each are a protruding block which snaps to the corresponding recessed groove,
the outer housing further comprises a first spacing plate which is positioned at a side of the first housing retain portion, and a second spacing plate which is positioned at a side of the second housing retain portion,
the first wafer and the fourth wafer each further comprise an end segment,
the first wafer retaining portion and the end segment of the first wafer are spaced apart from along a vertical direction perpendicular to the inserting direction and together clamp the first spacing plate,
the second wafer retaining portion and the end segment of the fourth wafer are spaced apart from along the vertical direction and together clamp the second spacing plate.

13. The connector of claim 8, wherein
the outer housing further comprises at least one latching member,
the latching member is positioned to any one of sides of the outer housing and is provided to latch and lock one of the first wafer, the second wafer, the third wafer and the fourth wafer in the inserting direction.

14. The connector of claim 8, wherein
one of the first wafer and the second wafer is formed with a retaining groove, and the other of the first wafer and the second wafer has a retaining block which snaps to the retaining groove,
one of the third wafer and the fourth wafer is formed with a retaining groove, and the other of the third wafer and the fourth wafer has a retaining block which snaps to the retaining groove.

15. The connector of claim 8, wherein
the first wafer, the second wafer, the third wafer and the fourth wafer each comprise a plurality of terminals, and a shielding member which locally covers the plurality of terminals,
one of the shielding member of the first wafer and the shielding member of the second wafer is formed with a retaining groove, and the other of the shielding member of the first wafer and the shielding member of the second wafer has a retaining block which snaps to the retaining groove,
one of the shielding member of the third wafer and the shielding member of the fourth wafer is formed with a retaining groove, and the other of the shielding member of the third wafer and the shielding member of the fourth wafer has a retaining block which snaps to the retaining groove.

16. The connector of claim 14, wherein
the retaining block has a long block body and two snapping block bodies,
a length direction of the long block body extends along the inserting direction,
the two snapping block bodies respectively protrude from two long sides of the long block body and are respectively adjacent to two short sides of the long block body, the two snapping block bodies snap to the corresponding retaining groove.

17. The connector of claim 8, wherein
the second wafer has a first snapping member,
the third wafer has a second snapping member which snaps to the first snapping member.

18. The connector of claim 8, wherein
the second wafer and the third wafer each comprises a plurality of terminals, and a supporting shelf which is overmolded to the plurality of terminals,
the supporting shelf of the second wafer has a first snapping member,
the supporting shelf of the third wafer has a second snapping member which snaps to the first snapping member.

19. The connector of claim 17, wherein
the first snapping member has at least one first snapping hook, the first snapping hook has a first hook portion which extends along the inserting direction,
the second snapping member has at least one second snapping hook, the second snapping hook has a second hook portion which extends along the inserting direction and snaps to the first hook portion.

20. The connector of claim 19, wherein
the first snapping member has two first snapping hooks, the two first snapping hooks are oppositely provided along a horizontal direction perpendicular to the inserting direction and are spaced apart from each other, each first snapping hook further has a strengthening wall portion which is connected to a side of the first hook portion and extends along the inserting direction,
the second snapping member has a strengthening block, and two second snapping hooks which respectively protrude from opposite sides of the strengthening block and are spaced apart from each other along the horizontal direction.

21. The connector of claim 8, wherein
the first wafer, the second wafer, the third wafer and the fourth wafer each comprise a plurality of terminals, a supporting shelf which is overmolded to the plurality of terminals, and a shielding member which locally covers the plurality of terminals,
one of the supporting shelf and the shielding member is formed with a positioning hole, and the other of the supporting shelf and the shielding member has a positioning post which snaps to and interferes with the positioning hole.

22. The connector of claim 8, wherein
the outer housing comprises a main housing body, an upper protrude housing body which protrudes from the main housing body, extends along the inserting direction, and is formed with the upper port, and a strengthening bracket which is connected between a bottom end of the upper protrude housing body and the main housing body.

23. The connector of claim 8, wherein
the outer housing further is formed with a lower port which is communicated with the cavity,
the outer housing further comprises a third housing retain portion and a fourth housing retain portion which are positioned in the cavity,
the wafer assembly further comprises a fifth wafer, a sixth wafer, a seventh waferand an eighth wafer which are mutually stacked and are retained,
the fifth wafer comprises a third wafer retaining portion which is retained to the third housing retain portion,
the eighth wafer comprises is a fourth wafer retaining portion which is retained to the fourth housing retain portion,
at least one of the third housing retain portion and the third wafer retaining portion extends along the inserting direction,
at least one of the fourth housing retain portion and the fourth wafer retaining portion extends along the inserting direction.

24. The connector of claim 23, wherein
the third housing retain portion and the fourth housing retain portion each are a recessed groove which extends along the inserting direction and is communicated with the cavity,
the third wafer retaining portion and the fourth wafer retaining portion each are a protruding block which snaps to the corresponding recessed groove.

25. The connector of claim 24, wherein
the outer housing further comprises a third spacing plate which is positioned between the third housing retain portion and the cavity, and a fourth spacing plate which is positioned between the fourth housing retain portion and the cavity,
the fifth wafer and the eighth wafer each further comprise a plurality of terminals, and a supporting shelf which is overmolded to the plurality of terminals, the supporting shelf has a shelf body which is molded to the plurality of terminals,
the third wafer retaining portion protrudes from an outer surface of the shelf body of the fifth wafer, and the third wafer retaining portion and the shelf body of the fifth wafer together clamp the third spacing plate,
the fourth wafer retaining portion protrudes from an outer surface of the shelf body of the eighth wafer, and the fourth wafer retaining portion and the shelf body of the eighth wafer together clamp the fourth spacing plate.

26. The connector of claim 25, wherein
the third wafer retaining portion and the shelf body of the fifth wafer together form a Y-shape,
the fourth wafer retaining portion and the shelf body of the eighth wafer together form a Y-shape.

27. The connector of claim 23, wherein
the third housing retain portion and the fourth housing retain portion each are a recessed groove,
the third wafer retaining portion and the fourth wafer retaining portion each are a protruding block which snaps to the corresponding recessed groove,
the outer housing further comprises a third spacing plate which is positioned at a side of the third housing retain portion, and a fourth spacing plate which is positioned at a side of the fourth housing retain portion,
the fifth wafer and the eighth wafer each further comprise an end segment,
the third wafer retaining portion and the end segment of the fifth wafer are spaced apart from each other along a vertical direction perpendicular to the inserting direction and together clamp the third spacing plate,
the fourth wafer retaining portion and the end segment of the eighth wafer are spaced apart from along the vertical direction and together clamp the fourth spacing plate.

28. The connector of claim 23, wherein
one of the seventh wafer and the eighth wafer is formed with a retaining groove, and the other of the seventh wafer and the eighth wafer has a retaining block which snaps to the retaining groove.

29. The connector of claim 23, wherein
the seventh wafer and the eighth wafer each comprise a plurality of terminals, and a shielding member which locally covers the plurality of terminals,
one of the shielding member of the seventh wafer and the shielding member of the eighth wafer is formed with a retaining groove, and the other of the shielding member of the seventh wafer and the shielding member of the eighth wafer has a retaining block which snaps to the retaining groove.

30. The connector of claim 28, wherein
the retaining block has a long block body and two snapping block bodies,
a length direction of the long block body extends along the inserting direction,
the two snapping block bodies respectively protrude from two long sides of the long block body and are respectively adjacent to two short sides of the long block body, the two snapping block bodies snap to the corresponding retaining groove.
